(19) United States
(12) Patent Application Publication
(10) Pub. No.: US 2012/0058228 A1
(43) Pub. Date: Mar. 8, 2012

(54) CHOCOLATE COMPOSITION

(75) Inventors: Andrew Wales, Warwickshire (GB); Anthony James Brown, Berkshire (GB); Christopher Chilton, Birmingham (GB); Philip John Winder, Woodseats Sheffield (GB); Shantanu Samant, Maharashtra (IN); K. Sriram, Ramadan (EG)

(73) Assignee: CADBURY UK LIMITED, West MIdlands (UK)

(21) Appl. No.: 13/264,775

(22) PCT Filed: Apr. 19, 2010
(86) PCT No.: PCT/GB2010/000779

§ 371 Date: Nov. 17, 2011

(30) Foreign Application Priority Data
Apr. 17, 2009 (GB) 0906662.2

(51) Int. Cl. A23G 1/46; A23G 1/54

(52) U.S. Cl. 426/93; 426/631

(57) ABSTRACT

A chocolate composition and a process for the manufacture of a chocolate composition. The chocolate composition comprises cocoa butter substitute/cocoa butter equivalent in combination with whey. In particular, the composition comprises 40-70 wt % sweetener, 25-30 wt % cocoa butter substitute (CBS) and/or cocoa butter equivalent (CBE), 4-10 wt % non-fat cocoa solids, milk solids and from 0-2 wt % cocoa butter, wherein at least 80 wt % of the milk solids are constituted by whey.

The invention relates to a chocolate composition and to a process for the manufacture of a chocolate composition.

Conventional milk chocolate is usually prepared from sugar, cocoa solids, cocoa butter and milk solids. Due to the high cost and the low melting point of cocoa butter there has been interest in replacing some or all of the cocoa butter in milk chocolate with cocoa butter substitutes (CBS, also known as cocoa butter replacers) or cocoa butter equivalents (CBE, fats having the same physical properties as cocoa butter where the constituent glycerides are not derived from the cocoa bean). Compositions containing predominantly CBS/CBE are often known as compound chocolates. They are commonly employed as coatings, particularly for products where a standard chocolate coating would not be suitable, for example, for coating ice-cream where a standard chocolate coating would be too brittle.

An objective of the present invention is the provision of an improved chocolate composition.

According to a first aspect of the present invention there is provided a chocolate composition comprising 40-70 wt % sweetener, 25-30 wt % cocoa butter substitute (CBS) and/or cocoa butter equivalent (CBE), 4-10 wt non-fat cocoa solids, milk solids and from 0 to 2 wt % cocoa butter, wherein at least 80 wt % of the milk solids are constituted by whey.

The invention provides an alternative to conventional milk chocolate which achieves a good taste and texture profile at lower cost. Confectionery products comprising a composition in accordance with the invention can therefore be made available to a wider range of consumers than previously.

The whey must comprise whey protein. It will be understood that whey permeate, a whey product from which the proteins have been removed, is not whey within the context of the present invention.

Useful sources of whey include whey protein concentrate, whey protein isolate, whey protein hydrolysate or a combination thereof. The whey may be demineralised. The composition will typically be prepared from whey powder. Whey powders comprise whey protein, optionally together with other components such as lactose.

The presence of whey protein is thought to be beneficial to the taste and texture of the product. In a series of embodiments, the whey comprises at least 25 wt %, at least 40 wt %, at least 50 wt %, at least 60 wt %, at least 70 % wt %, or at least 80 wt % whey protein.

In a series of embodiments, at least 90 wt %, at least 95 wt % or 100 wt % of the milk solids are constituted by whey.

When whey constitutes less than 100 wt % of the milk solids, the remaining milk solids may be in the form of skimmed milk solids and/or full cream milk solids.

In a series of embodiments, the composition comprises from 5 to 25 wt %, from 8 to 20 wt % or from 10 to 15 wt % whey.

The presence of non-fat cocoa solids lends the product the characteristic taste and colour of chocolate. In a series of embodiments, the composition comprises from 4 to 10 wt %, from 4 to 8 wt %, from 4 to 7 wt %, from 4 to 6 wt %, from 4to 5 wt %, from 5 to 8 wt %, from 5 to 7 wt % or from 5 to 6 wt % non-fat cocoa solids. Cocoa powder may be employed to provide the non-fat cocoa solids in the composition, in which case it will be understood that the cocoa butter present in the cocoa powder contributes to the overall amount of cocoa butter in the composition. A typical cocoa powder may have a fat content of from 10-12 wt %, so a recipe comprising 5 wt % cocoa powder has approximately 4.4-4.5 wt % non-fat cocoa solids.

Suitable sweeteners include sugars (e.g. sucrose, dextrose, glucose syrup solids, fructose, lactose, maltose or any combination thereof), sugar alcohols (e.g. erythritol, sorbitol, xylitol, mannitol, lactitol, isomalt, or any combination thereof), intense sweeteners (e.g. aspartame, acesulfame-k, cyclamates, saccharin, sucralose, neohesperidin, dihydrochalone, alitame, stena sweeteners, glycyrrhizin or any combination thereof) and any combination of sugars, sugar alcohols and intense sweeteners. In a certain embodiment the sweetener is sucrose.

In a series of embodiments the composition comprises from 40 to 65 wt %, from 45 to 63 wt %, from 45 to 60 wt %, from 50 to 65 wt %, from 52 to 63 wt %, from 52 to 58 wt %, from 57 to 63 wt %, from 50 to 55 wt % sweetener, from 55 to 60 wt % or from 60 to 65 wt %.

In one embodiment, the composition comprises a CBE. CBEs are defined in Directive 2000/36/EC. Suitable CBEs include illipe, Borneo tallow, tengkawang, palm oil, sal, shea, kokum gurgi and mango kernel.

In another embodiment, the composition comprises a CBS. Suitable CBSs include CBS laurics and CBS non-laurics. CBS laurics are short-chain fatty acid glycerides. Their physical properties vary within the group but they all have triglyceride configurations that make them compatible with cocoa butter. Suitable CBS laurics include those based on palm kernel oil and coconut oil. CBS non-laurics consist of fractions obtained from hydrogenated oils. The oils are selectively hydrogenated with the formation of trans acids, which increases the solid phase of the fat. Suitable sources for CBS non-laurics include soya, cottonseed, peanut, rapeseed and corn (maize) oil.

In a further embodiment, the composition comprises a CBE and a CBS. In a series of embodiments the composition comprises from 25 to 30 wt %, from 26 to 29 wt % or from 27 to 28 wt % CBS and/or CBE.

In a particular embodiment the composition comprises no more than 2 wt % or no more than 1 wt % cocoa butter.

In a specific embodiment the composition comprises 50-55 wt % sweetener, 25-30 wt % cocoa butter substitute, 10-15 wt % demineralised whey, 4-8 wt % non-fat cocoa solids and 0-2 wt % cocoa butter.

In another specific embodiment the composition comprises 55-60 wt % sweetener, 25-30 wt % cocoa butter substitute, 5-10 wt % demineralised whey, 4-8 wt % non-fat cocoa solids and 0-2 wt % cocoa butter.

In a further specific embodiment the composition comprises 60-65 wt % sweetener, 25-30 wt % cocoa butter substitute, 3-5 wt % demineralised whey, 4-8 wt % cocoa butter solids and 0-2 wt % cocoa butter.

In order to improve the viscosity during processing of the composition, the composition will commonly comprise at least one emulsifier. Such emulsifiers include lecithin derived from soya bean, safflower, sunflower, corn etc., fractionated lecithins enriched with either phosphatidyl choline, phosphatidyl ethanolamine, phosphatidyl inositol; emulsifiers derived from oats, mono- and diglycerides and their tartaric esters, monosodium phosphate derivatives of mono- and diglycerides of edible fats and oils, sorbitan monostearate, polyoxyethylene sorbitan monostearate, hydroxylated lecithin, synthetic phospholipids such as ammonium phosphatides, polyglycerol polyricinoleate (PGPR), lactylated fatty acid esters of glycerol and propylene glycol, polyglycerol esters of fatty acids, citric acid esters of fatty acids, propylene glycol mono- and diesters of fats and fatty acids.

The composition may further comprise natural and/or synthetic flavourings, especially those traditionally associated with chocolate, such as vanilla, orange and mint.

Advantageously, the composition is suitable for use both as a moulded product and as a coating. In a particular embodiment, the composition enrobes a centre such as a wafer or a number of wafers to form a snack bar. In a further embodiment, the snack bar has a centre that comprises a number of wafers that are sandwiched together by a filling, e.g. a confectionery cream, between the wafers.

According to a second aspect of the present invention, there is provided a process for the manufacture of the chocolate composition of the first aspect comprising mixing at least a sweetener, a cocoa butter substitute and/or a cocoa butter equivalent, non-fat cocoa solids and milk solids to form a paste, and processing the paste to form the chocolate composition;

wherein at least 80 wt % of the milk solids are constituted by whey

In one embodiment the processing comprises the steps of adjusting the particle size of the paste to a predetermined range; and liquefying the paste whereby to effect flavour development

Typically the paste will be milled to a particle size having a d90 of from 5 to 65 μm from 10 to 45 μm, or from 15 to 30 μm.

In certain embodiments, the liquefied composition is subjected to a tempering step.

The sweetener, non-fat cocoa solids, CBS/CBE and whey are as described for the first aspect of the invention.

An embodiment of the invention will now be described by way of example only.

### EXAMPLES

Chocolate compositions containing a cocoa butter substitute were prepared from the ingredients listed in the table below using the following method:

The dry ingredients (i.e. sugar, cocoa powder, whey powder and flavours) were mixed together for 10 minutes in a jacketed Hobart mixer at a temperature of 45 to 50° C. Fat (i.e. cocoa butter substitute, cocoa butter, emulsifiers) was added to the Hobart mixer to produce a consistent paste. The paste was roll refined to produce a refiner flake having a reduced particle size. The refiner flake was conched by mixing in a jacketed Hobart mixer at a temperature of 45 to 50° C. for around 3 hours. Finally, the mixture was hand tempered and either moulded into bars or used to enrobe a wafer centre.

| | | | | | Comp |
|---|---|---|---|---|---|
| Ingredient (wt %) | Ex 1 | Ex 2 | Ex 3 | Ex 4 | Ex 1 |
| Sugar (sucrose) | 52.45 | 52.45 | 57.45 | 62.45 | 52.45 |
| Cocoa butter substitute | 27.31 | 0 | 0 | 0 | 0 |
| (PALKENA (RTM), a CBS | | | | | |
| non-lauric, supplied by Fuji Oil | | | | | |
| Co. Ltd, Japan) | | | | | |
| Cocoa butter substitute | 0 | 27.31 | 27.31 | 27.31 | 27.31 |
| (CHOKITA), a lauric based | | | | | |
| CBS supplied by Kamani Oil | | | | | |
| Industries, India) | | | | | |
| Demineralised whey powder | 14.00 | 14.00 | 9.00 | 4.00 | 0 |
| (comprising whey protein) | | | | | |
| Skimmed milk powder | 0 | 0 | 0 | 0 | 14.00 |
| Cocoa powder | 5.00 | 5.00 | 5.00 | 5.00 | 5.00 |
| Cocoa butter | 0.50 | 0 | 0 | 0 | 0 |
| CBS fat for flavour block | 0 | 0.50 | 0.50 | 0.50 | 0.50 |
| Emulsifiers | 0.73 | 0.73 | 0.73 | 0.73 | 0.73 |
| Flavours | 0.03 | 0.03 | 0.03 | 0.03 | 0.03 |

Consumer research results identified that the compositions were found to be acceptable alternatives to a conventional milk chocolate. In addition, when each composition was used to enrobe a wafer centre, the resulting snack bar was found to be as well received as comparable snack bars on the market despite being produced at lower cost.

A study was carried out to determine the drivers of consumer acceptance in emerging markets and the following results were obtained:

| Flavour | Priority No |
|---|---|
| High milky, sweet | 1 |
| High vanilla | 1 |
| Low | 4 |
| sour milk | |
| Low | 4 |
| condensed milk | |
| Low wafer to choc. ratio | 5 |
| Not stale | 5 |
| Not burnt | 8 |
| Low caramel | 9 |

Hence high milky, sweet and vanilla flavours are considered to be the most important drivers in this market.

| Texture | Priority No |
|---|---|
| Fast melt rate | 2 |
| Waxy | 6 |
| Crispy, crumbly | 7 |
| Initial hardness | 7 |
| Not chewy | 7 |

Snack bars were prepared by enrobing a wafer centre with the compositions of

Examples 2 to 4 and Comp Ex 1 and assessed together with other wafer products available on the market. The comparative samples were: Cadbury Product A (South Africa), Cadbury Product B (UK), Cadbury Product C (South Africa), Cadbury Product D (South Africa), Cadbury Product E (Russia), Cadbury Product F (India), Cadbury Product G (India), Competitor Product H (India), Competitor Product I (India), Competitor Product J (India) and Competitor Product K (India).

The samples were assessed by a panel of trained assessors for their flavour and texture. Results were collected via the Compusense data capture system (Compusense Five, Canada) and were analysed with QDA™ software (Tragon) using analysis of variance (ANOVA). The Duncan minimum significant difference was calculated in order to determine for each attribute, those samples, which were significantly different (p<0.05). A Principal Component Analysis (PCA) was run in FIZZ (Biosystemes, France) to describe the main sensory differences between the samples.

| | | Priority | |
|---|---|---|---|
| Flavour | Target | No | Summary of the significant differences |
| High sweet | Cadbury | 1 | There were no significant differences between Ex 3 |
| | Products B, C | | and Ex 4, and Cadbury Products B, C and D in |
| | and D | | terms of sweetness. |
| High milky | Cadbury | 1 | There were no significant differences between Ex |
| | Products B, C | | 3, Ex 4, Comp Ex 1, and Cadbury Products B, C |
| | and D | | and D in terms of milky flavour. |
| High vanilla | Cadbury | 1 | There were no significant differences between Ex 2 |
| | Product C | | to 4, Comp Ex 1 and Cadbury Product C in terms of |
| | | | vanilla flavour. |
| Low | Competitor | 4 | Ex 2 to 4 and Comp Ex 1 were significantly less |
| sour milk | Products I and J | | sour milk than Cadbury Product C and were not |
| | | | significantly different to Competitor Products I and J |
| | | | in sour milk flavour. |
| Low | Competitor | 4 | Ex 2 to 4 and Comp Ex 1 are less condensed milk |
| condensed | Products I and J | | than Cadbury Product C and were not significantly |
| milk | | | different to Competitor Product I and J in |
| | | | condensed milk flavour. |
| Not stale | | 5 | There were no significant differences between Ex 2 |
| | | | to 4, Comp Ex 1 and Competitor Product H in terms |
| | | | of stale flavour. |
| Not burnt | | 8 | Ex 2 to 4 and Comp Ex 1 were significantly less |
| | | | burnt than Cadbury Product E and were not |
| | | | significantly different to Competitor Product H in |
| | | | flavour. |
| Low | Competitor | 9 | Ex 2 to 4 were significantly less caramel than |
| caramel | Products I and J | | Cadbury Product C and were not significantly |
| | | | different from Competitor Products I and J in |
| | | | caramel flavour. |

| | Priority | |
|---|---|---|
| Texture | No | Summary of the significant differences |
| Fast melt | 2 | The results showed that there were no significant differences between |
| rate | | Ex 2 to 4 and Comp Ex 1 in terms of melt rate in texture. |
| Crispy, | 7 | There were no significant differences between Ex 2 to 4 and Comp Ex |
| crumbly | | 1 and Cadbury Product D in terms of crispy and crumbly texture. |
| Initial | 7 | Ex 2 and 4 were found to be significantly less hard to bite through than |
| hardness | | Cadbury Product D and Competitor Product J. There were no |
| | | significant differences between Ex 3 and Comp Ex 1 and Cadbury |
| | | Product D in terms of hardness texture. |

This analysis shows that the compositions of the invention have key product attributes that have been identified as drivers in product liking. The products perform well in terms of high sweet, high milky and high vanilla, all which were considered to be high priority attributes for consumer acceptance.

Furthermore, it will be noted that replacing conventional skimmed milk powder (Comp Ex 1) with whey has no adverse effects on the listed flavour attributes.

Effect of Sugar Content on Sensory Attributes

The sugar content of the compositions increases from Ex 2 (52.45 wt %), Ex 3 (57.45 wt %) to Ex 4 (62.45 wt %). The variation in sugar content was analysed by testing the wafer products against the sensory attributes listed below (A=aroma, T MF=texture/mouthfeel, F=flavour, AT=aftertaste).

The sugar content was found to have a significant impact (✓✓) on the perception of that attribute (confidence of P<0.05) or to have some influence (✓) on the level of perception of that attribute (confidence of 0.1>P>0.05).

| | Sugar content |
|---|---|
| A Overall aroma | |
| A Sweet | |
| A Milky | ✓✓ |
| A Vanilla | |
| A Burnt | |
| T MF Hard | |
| T MF Adhesive | |
| T MF Mouthcoating | ✓ |
| F Cocoa | ✓ |
| F Sweet | ✓✓ |
| F Bitter | ✓✓ |
| F Burnt | ✓ |
| F Vanilla | ✓✓ |
| F Stale | |
| AT Overall Aftertaste | |
| AT Cocoa | ✓ |
| AT Sweet | ✓✓ |
| AT Bitter | ✓✓ |
| AT Burnt | ✓ |
| AT Vanilla | ✓✓ |

Hence it can be seen that the sugar content has particular influence in terms of the key attributes of milky, sweet and vanilla. Hence the composition with the highest sugar content (Ex 4) is considered to be particularly beneficial when these attributes are required.

1. A chocolate composition comprising 40-70 wt % sweetener, 25-30 wt % cocoa butter substitute (CBS) and/or cocoa butter equivalent (CBE), 4-10 wt % non-fat cocoa solids, milk solids and from 0-2 wt % cocoa butter, wherein at least 80 wt % of the milk solids are constituted by whey.

2. The composition of claim 1, wherein the whey comprises at least 25 wt % whey protein.

3. The composition of claim 1, wherein 100 wt % of the milk solids are constituted by the whey.

4. The composition of claim 1, comprising from 5 to 25 wt % whey.

5. The composition of claim 1, wherein the CBS is a lauric-based cocoa butter substitute.

6. The composition of claim 1, wherein the CBS is a non-lauric based cocoa butter substitute.

7. The composition of claim 1, comprising 50-55 wt % sweetener, 25-30 wt % cocoa butter substitute, 10-15 wt % demineralised whey, 4-8 wt % non-fat cocoa solids and 0-2 wt % cocoa butter.

8. The composition of claim 1, comprising 50-70 wt % sweetener, 25-30 wt % cocoa butter substitute, 5-15 wt % demineralised whey, 4-8 wt % non-fat cocoa solids and 0-2 wt % cocoa butter.

9. A snack bar comprising a wafer centre and a coating comprising the composition of claim 1.

10. A process for the manufacture of the chocolate composition of claim 1 comprising
mixing at least 40-70 wt % of a sweetener, 25-30 wt % of a cocoa butter substitute and/or a cocoa butter equivalent, 4-10 wt % non-fat cocoa solids and milk solids to form a paste, and
processing the paste to form the chocolate composition;
wherein at least 80 wt % of the milk solids are constituted by whey.

11. The process of claim 10, wherein the processing comprises the steps of adjusting the particle size of the paste to a predetermined range; and liquefying the paste whereby to effect flavour development.
